(19) United States
(12) Patent Application Publication
(10) Pub. No.: US 2021/0135273 A1
(43) Pub. Date: May 6, 2021

(54) PRODUCTION METHOD FOR ELECTROCHEMICAL DEVICE

(71) Applicant: DAI-ICHI KOGYO SEIYAKU CO., LTD., Kyoto-shi, Kyoto (JP)

(72) Inventors: Yasuteru SAITOU, Kyoto (JP); Junshi OKUHARA, Kyoto (JP)

(73) Assignee: DAI-ICHI KOGYO SEIYAKU CO., LTD., Kyoto-shi, Kyoto (JP)

(21) Appl. No.: 16/473,984

(22) PCT Filed: Dec. 5, 2017
(86) PCT No.: PCT/JP2017/043566

§ 371 Date: Jun. 26, 2019

(30) Foreign Application Priority Data
Dec. 27, 2016 (JP) 2016-253193
Nov. 6, 2017 (JP) 2017-214100

(51) Int. Cl. H01M 10/058; H01G 11/56; H01G 11/84; H01G 9/20; H01M 10/0565; H01M 10/0525

(52) U.S. Cl. CPC H01M 10/058; H01G 11/56; H01M 10/0525; H01G 9/20; H01M 10/0565; H01G 11/84

(57) ABSTRACT

The production method is for an electrochemical device equipped with a pair of electrodes and an electrolyte located therebetween. The electrolyte with which the electrochemical device is provided is a gel-form body constituted by at least a matrix material and an electrolytic solution, contains cross-linkable reaction groups, and has a raised gel electrolyte hardening degree (hard gel electrolyte). The production method for the electrochemical device comprises an electrolyte hardening degree raising step of causing, with the gel electrolyte in a held state between the pair of electrodes, a crosslinking of the reaction groups to proceed, thereby causing the gel electrolyte hardening degree to be raised, while causing the electrolytic solution to seep out from the gel electrolyte as crosslinking proceeds.

### TECHNICAL FIELD

The present invention relates to a method for producing an electrochemical device which is a device including a pair of electrodes and an electrolyte interposed therebetween and in which an electrochemical reaction is utilized. The invention relates to the method for producing an electrochemical device, which device is suitable for use in producing, for example, a lithium ion battery, a dye-sensitized solar cell, or an electric double-layer capacitor.

### BACKGROUND ART

Known as electrochemical devices in which electrochemical reactions are used include, for example, various kinds of batteries, some of solar cells, and capacitors. Liquids (electrolytic solutions) have conventionally been used as electrolytes in those electrochemical devices. However, when the electrolyte is a common electrolytic solution, there inevitably is a possibility that the electrolyte might leak out from the electrochemical device. Under these circumstances, the following have, for example, been proposed recently: a configuration in which a gel electrolyte obtained by gelating an electrolytic solution is used, as in the electrochemical battery and method for production thereof disclosed in Patent Document 1; and the configuration disclosed in Patent Document 2 in which a solid electrolyte is used.

### BACKGROUND ART DOCUMENTS

### Patent Documents

Patent Document 1: JP-T-2011-519116
Patent Document 2: JP-A-10-321040

### SUMMARY OF THE INVENTION

### Problem that the Invention is to Solve

However, for the configuration in which a gel electrolyte is used as the electrolyte of an electrochemical device, the step of injecting an electrolytic solution is necessary. Since this step may require a relatively long time period, there is a concern that the steps for producing the electrochemical device cannot be made sufficiently efficient.

Meanwhile, in the configuration in which a solid electrolyte is used as the electrolyte of an electrochemical device, the solid electrolyte is in point contact with the electrodes. Because of this, when the number of sites where the point contact occurs is too small, there is a concern that the electrochemical device might have an increased contact resistance between the solid electrolyte and each electrode.

The present invention has been achieved in order to overcome such problems. An object of the present invention is to provide a method for producing an electrochemical device, the method being capable of not only rendering production steps efficient but also producing an electrochemical device, which can have satisfactory device performances.

### Means for Solving the Problem

A method for producing an electrochemical-device according to an aspect of the present invention, which is for overcoming the problems described above, is a method for producing an electrochemical device including a pair of electrodes and an electrolyte interposed therebetween, the electrolyte being a gel electrolyte that is a gel-state object configured of at least a matrix material and an electrolytic solution, and that contains reactive groups capable of crosslinking, and that has an increased degree of hardening, the method having a configuration including a step for causing a crosslinking reaction of the reactive groups to proceed, and increasing the degree of hardening of electrolyte, and causing some of the electrolytic solution to seep out from the gel electrolyte as the crosslinking reaction proceeds while holding the gel electrolyte between the pair of electrodes.

### Advantages of the Invention

Due to the above configuration, the present invention produces the effect of being capable of providing a method for producing an electrochemical device, which is capable of not only rendering production steps efficient, but also producing an electrochemical device, which can have satisfactory device performances.

### BRIEF DESCRIPTION OF THE DRAWINGS

FIG. 1 is a schematic cross-sectional view showing one example of the configuration of a lithium ion battery as an electrochemical device according to one embodiment of the present invention.

FIG. 2 is a flow chart roughly showing an example of method for producing the electrochemical device according to an embodiment of the present invention.

FIG. 3(A) is flow diagrams, which schematically show steps for producing the lithium ion battery shown in FIG. 1, and FIG. 3(B) is flow diagrams, which schematically show steps for producing a conventional lithium ion battery.

### MODES FOR CARRYING OUT THE INVENTION

The method for producing an electrochemical device according to this disclosure is a method for producing an electrochemical device including a pair of electrodes and an electrolyte interposed therebetween, in which the electrolyte being a gel electrolyte that is a gel-state object configured at least of a matrix material and an electrolytic solution, and that contains reactive groups capable of crosslinking, and that has an increased degree of hardening, and the method having a configuration includes a step for causing a crosslinking reaction of the reactive groups to proceed and increasing the degree of hardening of the electrolyte, and causing some of the electrolytic solution to seep out from the gel electrolyte as the crosslinking reaction proceeds, while holding the gel electrolyte between the pair of electrodes.

In accordance with the configuration, in the step for increasing the degree of hardening of electrolyte, the gel electrolyte in the state of being held between a pair of electrodes is increased in the degree of hardening and some of the electrolytic solution is caused to seep out from the gel electrolyte as if it oozes out. Because of this, even after the gel electrolyte has become one (hard gel electrolyte) having a sufficiently increased degree of hardening, this gel electrolyte contains a sufficient amount of a gel electrolytic solution and the electrolytic solution, which has seeped out, is in satisfactory contact with the contact surfaces of the pair of electrodes. Thus, a satisfactory contact area can be rendered possible at the interface between the electrolyte and each electrode and, hence, the reaction resistance can be effectively inhibited from increasing.

In addition, since the gel electrolyte is a gel-state object configured of a matrix material and an electrolytic solution, not only the injection of an electrolytic solution, which is an essential step in conventional production processes, is unnecessary but also the possibility of resulting in a shortage in electrolytic-solution injection can be avoided even when the electrochemical device is large. Thus, not only the production steps can be rendered efficient but also satisfactory device performances and long-term reliability can be rendered possible. Furthermore, since the gel electrolyte having an increased degree of hardening can function as a separator, a separator is not an essential constituent element in this electrochemical device. It is hence possible to reduce the number of members necessary for constituting the electrochemical device.

In the method for producing an electrochemical device having the configuration described above, the configuration may be the one in which the pair of electrodes is a positive electrode and a negative electrode, and at least one of the positive and negative electrodes has a porous surface as a surface in contact with the electrolyte.

According to this configuration, since either or both of the pair of electrodes, i.e., a positive electrode and a negative electrode, have a porous surface as a contact surface, the contact between each of the positive and negative electrodes and the electrolytic solution contained in the gel electrolyte can be made to occur in an increased area.

In the method for producing an electrochemical device having the configuration described above, the configuration may be the one in which at least one of the pair of electrodes includes an active-material layer formed in a surface in contact with the electrolyte, the active-material layer being formed by applying a coating fluid containing an active material.

According to this configuration, since an active-material layer is formed on a contact surface of an electrode by applying a coating fluid, the active-material layer can be easily formed as a thin layer.

In the method for producing an electrochemical device having the configuration described above, the configuration may be the one in which the coating fluid contains either the gel electrolyte or a hard gel electrolyte obtained by causing the gel electrolyte to have an increased degree of hardening.

According to this structure, the inclusion of either a gel electrolyte or a hard gel electrolyte makes it possible to further improve the frequency of contact between the active-material layer formed on a contact surface of the electrode and the gel electrolyte.

In the method for producing an electrochemical device having the configuration described above, the configuration may be the one in which the method further includes an sealing step which is performed before the step for increasing the degree of hardening of electrolyte and in which a multilayer structure including the pair of electrodes and the gel electrolyte held therebetween is sealed with a sealing material.

According to the method above, since the multilayer structure is sealed before the step for increasing the degree of hardening of electrolyte is performed, it is possible to increase the degree of hardening of the gel electrolyte in the state of being satisfactorily held between the pair of electrodes.

In the method for producing an electrochemical device having that configuration, the configuration may be the one in which, in the step for increasing the degree of hardening of electrolyte, energy is supplied to the gel electrolyte from outside the multilayer structure to cause the crosslinking reaction to proceed.

According to this configuration, since the degree of hardening of the gel electrolyte is increased by energy supplied from outside, the step for increasing the degree of hardening of electrolyte can be carried out without giving any physical operation to the gel electrolyte contained in the multilayer structure.

In the method for producing an electrochemical device having the configuration described above, the configuration may be the one in which the step for increasing the degree of hardening electrolyte further includes applying pressure to the gel electrolyte in the state of being held between the positive electrode and the negative electrode.

According to this configuration, since the gel electrolyte is pressed while being increased in the degree of hardening, it is possible to not only control the thickness of the gel electrolyte but also control the seepage of the electrolytic solution from the gel electrolyte.

In the method for producing an electrochemical device having the configuration described above, the configuration may be the one in which the electrochemical device is a lithium ion battery, a dye-sensitized solar cell, or an electric double-layer capacitor.

According to this configuration, as long as the electrochemical device is at least any of the devices shown above, by using the method for producing an electrochemical device according to this disclosure, an electrochemical device, which can have satisfactory device performances can be produced, while rendering the production steps efficient.

Representative embodiments of this disclosure are explained below by reference to the drawings. Hereinafter, like or corresponding elements are designated by like numerals throughout the drawings, and duplicates of explanation are omitted.

[Electrochemical Device]

The electrochemical device to be obtained by the method for producing an electrochemical device according to this disclosure may be any device in which an electrochemical reaction is utilized (device capable of converting chemical energy to electrical energy or vice versa). The electrochemical device may be any, as long as the device has a basic configuration, which includes a pair of electrodes and an electrolyte interposed therebetween.

The pair of electrodes included in the electrochemical device is not particularly limited in the specific configuration thereof. Typically, the pair of electrodes is configured of a positive electrode and a negative electrode. Although the positive and negative electrodes are not particularly limited in the specific configuration thereof, it is, for example, preferable that the contact surface (the surface facing the electrolyte) of each electrode is porous, in order for enabling the contact with the electrolytic solution contained in the electrolyte to occur in an increased area. The positive electrode only or the negative electrode only may have such a porous contact surface, or both the positive electrode and the negative electrode may have the porous contact surface. The pair of electrodes is not particularly limited in the more specific configuration thereof, and electrodes made of any of various materials and having any of various shapes, dimensions, etc. can be advantageously used in accordance with the kind, intended use, etc. of the electrochemical device.

Methods for forming the porous contact surface are not particularly limited. Representative examples thereof include a method in which a layer of a powder (or particles) of an electrode material (active material) is formed on a surface of an electrode base material. Examples of the method for forming a layer of such a powdery material include a method in which a powder of an electrode material (active material) is mixed with an organic vehicle (a solvent and/or a binder resin, etc.) to obtain a paste and this paste is applied to a surface of an electrode base material and then subjected to drying, curing, baking, etc.

The electrolyte included in the electrochemical device lies between the pair of electrodes. The electrolyte according to this disclosure may be one obtained from a gel electrolyte which is a gel-state object configured of an electrolytic solution and a matrix material having reactive groups capable of crosslinking, by causing the gel electrolyte to have an increased degree of hardening. The term “degree of hardening” herein means the degree to which the gel electrolyte has hardened, and the degree of hardening can be evaluated in terms of the degree of the crosslinking reaction of the reactive groups contained in the gel electrolyte or evaluated by, for example, a known method for determining the degree of hardening. In the following explanations, the gel electrolyte, which has an increased degree of hardening, is referred to as a “hard gel electrolyte” for reasons of convenience. In cases when an electrolyte is merely called a “gel electrolyte”, this gel electrolyte has not been increased in the degree of hardening.

The matrix material for constituting the gel electrolyte is not particularly limited so long as the matrix material in cooperation with an electrolytic solution can form a gel-state object (gel electrolyte). Suitable for use as the matrix material is, for example, a matrix material having reactive groups capable of crosslinking reaction. Alternatively, an electrolytic solution including an ingredient having a reactive group capable of crosslinking reaction with the matrix material can be used. Examples thereof include an ionic liquid, organic solvent, alkali metal salt, etc., which have a reactive group capable of crosslinking reaction. Namely, in this disclosure, the gel electrolyte may be one containing reactive groups capable of crosslinking reaction, and the reactive groups may be ones possessed by the matrix material or ones possessed by the electrolytic solution or may be ones possessed by both the matrix material and the electrolytic solution.

The gel-state object configured of a matrix material and an electrolytic solution is not particularly limited in the specific configuration thereof. Representative examples thereof include: a chemical gel in which a crosslinked structure is formed by covalent bonds and which has uncrosslinked reactive groups; a physical gel in which a crosslinked structure is formed by bonds other than covalent bonds and which has uncrosslinked reactive groups; and a chemical or physical gel which has no uncrosslinked reactive groups and which contains a compound or composition that has an uncrosslinked reactive group (referred to as “crosslinking reactive substance” for convenience).

These gels, which constitute a matrix material, are not particularly limited in the more specific configuration thereof, and any of various organic high-molecular-weight compounds, inorganic high-molecular-weight compounds, organic low-molecular-weight compounds, inorganic low-molecular-weight compounds, and the like may be used in accordance with the kind, intended use, etc. of the electrochemical device. In the case where the gel which constitutes a matrix material contains a crosslinking reactive substance, this crosslinking reactive substance is not particularly limited in the specific configuration thereof and any of various organic high-molecular-weight compounds, inorganic high-molecular-weight compounds, organic low-molecular-weight compounds, inorganic low-molecular-weight compounds, and the like may be used. Representative examples of the crosslinking reactive substance include prepolymers having uncrosslinked reactive groups.

The matrix material may be a material, which can constitute a gel-state object (gel-state electrolytic solution) upon impregnation with an electrolytic solution. Namely, the matrix material may be constituted as a material, which already has a matrix structure. Alternatively, the matrix material may be the one obtained by mixing a starting material for a matrix material with an electrolyte solution and then semi-curing the starting material to form a gel-state object containing an electrolytic solution (gel-state electrolytic solution).

In the gel electrolyte, which is a gel-state object configured of a matrix material and an electrolytic solution, a crosslinking reaction of the reactive groups contained in the gel-state object do not proceed until the gel electrolyte goes through the step for increasing the degree of hardening of electrolyte, which will be described later. In contrast, in the hard gel electrolyte, which has gone through the step for increasing the degree of hardening of electrolyte, the crosslinking reaction proceeds, resulting in a gel-state object having increased degree of hardening. In this disclosure, the gel electrolyte, which has not gone through the crosslinking reaction (i.e., which has not increased in the degree of hardening), is referred to simply as “gel electrolyte” as stated above and the gel electrolyte, which has gone through the crosslinking reaction to have an increased degree of hardening, is referred to as “hard gel electrolyte” as stated above.

Both the gel electrolyte before increasing the degree of hardening, and the hard gel electrolyte after increasing the degree of hardening, contain an electrolytic solution. Although this electrolytic solution may be any electrolytic solution, which carries out an electrochemical reaction when a voltage is applied between the pair of electrodes, representative examples thereof include a composition including a solvent and either an ionic substance or ion pairs. The electrolytic solution is not particularly limited in the more specific configuration thereof, and a known solvent, a known salt, etc. can be suitably selected and used in accordance with the kind or intended use of the electrochemical device, the kind of the matrix material which, together with the electrolytic solution, constitutes the gel electrolyte, etc. The electrolytic solution may suitably contain ingredients other than the solvent and the ionic substance or ion pairs.

The gel electrolyte before increasing the degree of hardening may contain other ingredients, e.g., various additives, besides the matrix material and the electrolytic solution. Specific examples of the additives include polymerization initiators for accelerating the crosslinking reaction of uncrosslinked reactive groups contained in the matrix material. In the Examples which will be described later, 2,2′-azobis(2,4-dimethylvaleronitrile) is used as an additive in Example 2.

In this disclosure, an electrochemical device which has not gone through the step for increasing the degree of hardening of electrolyte has a configuration including a pair of electrodes and the gel electrolyte interposed therebetween, while the electrochemical device which has gone through the step for increasing the degree of hardening of electrolyte has a configuration including the pair of electrodes and a hard gel electrolyte interposed therebetween. In this disclosure, the term “electrochemical device”, in a broad sense, means both one which has not gone through the step for increasing the degree of hardening of electrolyte and one which has gone through the step. However, for convenience of explanation, an electrochemical device which has not gone through the step for increasing the degree of hardening of electrolyte and an electrochemical device which has gone through the step for increasing the degree of hardening of electrolyte are referred, in a narrow sense, to as an “electrochemical device before degree of hardening increase” and an “electrochemical device after degree of hardening increase”, respectively.

In this disclosure, an electrochemical device before degree of hardening increase is only required to include the pair of electrodes and gel electrolyte described above, and an electrochemical device after degree of hardening increase is only required to include the pair of electrodes and hard gel electrolyte described above. However, the configurations of the electrochemical devices according to this disclosure are not limited to these, and the electrochemical devices may include constituent elements or members other than the pair of electrodes and the gel electrolyte or hard gel electrolyte. The other constituent elements or other members are not particularly limited in the specific configurations thereof, and various constituent elements or components according to specific kinds of the electrochemical devices can be used.

The electrochemical device according to this disclosure is not particularly limited in the specific configurations thereof, and may be any electrochemical device which has a configuration including a pair of electrodes and an electrolyte lying therebetween, as stated above, and in which an electrochemical reaction is utilized. Representative examples of the electrochemical device include lithium ion batteries, dye-sensitized solar cells, and electric double-layer capacitors.

[Lithium Ion Battery]

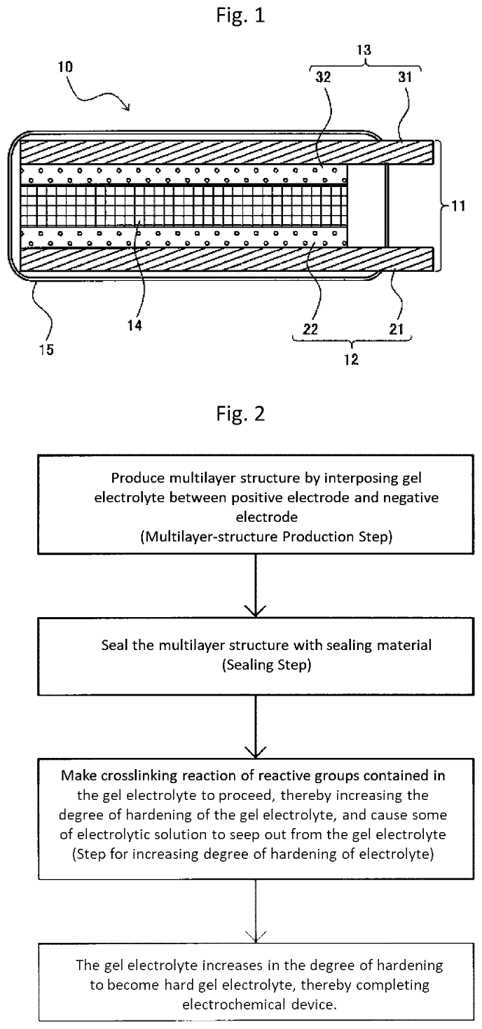

The specific configuration of a lithium ion battery, which is a representative example of the electrochemical device according to this disclosure is explained below in detail by reference to FIG. 1.

As FIG. 1 shows, the lithium ion battery 10, which is a kind of electrochemical device, has a configuration which includes a positive electrode 12 and a negative electrode 13, as a pair of electrodes, and a hard gel electrolyte 14 held between the positive electrode 12 and the negative electrode 13. The structure configured of stacked layers that are the positive electrode 12, the hard gel electrolyte 14, and the negative electrode 13 (structure in which the hard gel electrolyte 14 is held between the positive electrode 12 and the negative electrode 13) is referred to as a multilayer structure 11 for reasons of convenience. The lithium ion battery 10 has a configuration obtained by sealing the multilayer structure 11 with a sealing material 15.

The positive electrode 12 has a configuration including a positive-electrode base 21 material and a positive-electrode active-material layer 22 formed on a surface of the positive-electrode base 21 (the surface which faces the negative electrode 13 and is in contact with the hard gel electrolyte 14), as shown in FIG. 1. Likewise, the negative electrode 13 has a configuration including a negative-electrode base material 31 and a negative-electrode active-material layer 32 formed on a surface of the negative-electrode base 31 (the surface which faces the positive electrode 12 and is in contact with the hard gel electrolyte 14).

The positive-electrode base material 21 and the negative-electrode base material 31 function as current collectors which collect electrons yielded by electrochemical reactions of the positive-electrode active-material layer 22 and negative-electrode active-material layer 32. The positive-electrode base 21 and the negative-electrode base 31 are not particularly limited in the specific configurations thereof, and known metal plates or metal foils may be used. In the Examples, which will be described later, an aluminum foil is used as the positive-electrode base 21. As the negative-electrode base 31, a copper foil is representatively used.

Representative examples of positive-electrode active materials for use in the positive-electrode active-material layer 22 include, but are not particularly limited, lithium salts of transition-metal oxides. In the Examples, which will be described later, a Li—Ni—Co—Mn oxide (NCM), which is a ternary-metal lithium salt, is used as a positive-electrode active material. Representative examples of negative-electrode active materials for use in the negative-electrode active-material layer 32 are lithium metal foils or carbon materials. In the Examples, which will be described later, a lithium metal foil is used as a negative-electrode active material. The positive-electrode active-material layer 22 may be constituted of a positive-electrode active material alone, and the negative-electrode active-material layer 32 may be constituted of a negative-electrode active material alone. However, these active-material layers each may be configured as a layer containing other ingredients.

For example, in the case where the positive-electrode active-material layer 22 and the negative-electrode active-material layer 32 are each to be formed by applying a coating fluid containing an active material, the coating fluid may contain a known binder resin, e.g., poly(vinylidene fluoride) (PVDF), and a known conductive aid, e.g., carbon black. The coating fluid may contain a solvent (dispersion medium) besides the active material, binder resin, and conductive aid. From the standpoint of improving the frequency of contact with the positive-electrode active-material layer 22 or negative-electrode active-material layer 32, the coating fluid may contain either a gel electrolyte which has not increased in the degree of hardening or the gel electrolyte (hard gel electrolyte ingredient) which has increased in the degree of hardening to a degree similar to that of the hard gel electrolyte 14.

In the positive electrode 12, the positive-electrode active-material layer 22 constitutes a surface which faces the negative electrode 13 and which is in contact with the hard gel electrolyte 14. Likewise, the negative-electrode active-material layer 32 in the negative electrode 13 constitutes a surface which faces the positive electrode 12 and which is in contact with the hard gel electrolyte 14. It is therefore preferable that at least one of the positive-electrode active-material layer 22 and the negative-electrode active-material layer 32 is porous.

Methods for forming the active-material layers 22 and 32 as porous layers are not particularly limited, and various known techniques can be used. Representative examples thereof include a method in which a paste containing an active material is applied and dried, as stated above. Either of the active-material layers 22 and 32 may not be porous. In the Examples, which will be described later, the positive-electrode active-material layer 22 is formed as a porous layer and the negative-electrode active-material layer 32 is formed of a lithium foil only.

A lithium foil serves as both a negative-electrode active material and a current collector (negative-electrode base material 31). In the Examples, which will be described later, the negative electrode 13 is hence constituted of a lithium foil only. Consequently, either the positive electrode 12 or the negative electrode 13 does not need to have the configuration wherein the electrode is composed of an active-material layer 22 or 32 and a base material 21 or 31 which supports the active-material layer, as shown in FIG. 1.

The hard gel electrolyte 14 is formed by increasing degree of hardening of the gel electrolyte, as stated above. The electrolytic solution contained in the hard gel electrolyte 14 may be a solution obtained by dissolving a known lithium salt in a known solvent. Examples of the solvent include, but are not limited to, carbonate-based solvents, nitrile-based solvents, ether-based solvents, and ionic liquids. Representative examples of the lithium salt include, but are not limited to, lithium hexafluorophosphate (LiPF₆), lithium bis(trifluoromethanesulfonyl)imide (LiTFSI), and lithium bis(fluorosulfonyl)imide (LiFSI).

Representative solvents include mixed solvents each composed of a cyclic carbonate and a chain carbonate. Representative examples of the cyclic carbonate include, but are not particularly limited to, ethylene carbonate (EC) and propylene carbonate (PC), and representative examples of the chain carbonate include, but are not particularly limited to, dimethyl carbonate (DMC), diethyl carbonate (DEC), and ethyl methyl carbonate (EMC). In the Examples, which will be described later, a mixed solvent obtained by mixing ethylene carbonate and diethyl carbonate in a volume ratio of 3:7 is used as a solvent for the electrolytic solution.

Other representative solvents include ionic liquids. Specific examples thereof include, but are not limited to, 1,2-ethylmethylimidazolium bis(fluorosulfonyl)imide, 1,2-ethylmethylimidazolium bis(trifluoromethanesulfonyl)imide, N-methylpropylpyrrolidinium bis(fluorosulfonyl)imide, N-methylpropylpyrrolidinium bis(trifluoromethanesulfonyl)imide, diethylmethylmethoxyethylammonium bis(trifluoromethanesulfonyl)imide, diethylammonium bis(fluorosulfonyl)imide, diallyldimethylammonium (trifluoromethanesulfonyl)imide, and diallyldimethylammonium (fluorosulfonyl)imide.

The matrix material, which, together with the electrolytic solution, constitutes the gel electrolyte, may be any matrix material, which, in the state of containing the electrolytic solution, is capable of forming a gel-state object, as stated above. For example, a matrix material, which can be made to have an increased degree of hardening by causing reactive groups thereof to proceed a crosslinking reaction, is suitable for use. In this disclosure, examples of the matrix material, which has not increased in the degree of hardening, include a gel composition configured of: a physical or chemical gel having no uncrosslinked reactive groups; and a crosslinking reactive substance having an uncrosslinked reactive group.

As substances, which can be, the physical or chemical gel, known organic high-molecular-weight compounds can be used in accordance with the kind of the electrolytic solution. Examples of the crosslinking reactive substance include: compounds containing a double-bond functional group such as a (meth)acrylic group (acrylic or methacrylic group) or an allyl group; oxirane compounds such as epoxies and oxetane; and compounds containing a functional group (crosslinkable reactive group) capable of forming a bond such as a urethane bond, e.g., an isocyanate group or a blocked isocyanate group, or forming a bond such as a urea bond. Suitable for use as such a crosslinking reactive substance is, for example, a prepolymer as stated above. The crosslinking reactive substance may contain only one kind of such functional group(s) or may contain two or more kinds of such functional groups.

The proportion in which the chemical or physical gel is mixed with the crosslinking reactive substance is not particularly limited. The matrix material may contain ingredients other than the physical or chemical gel and the crosslinking reactive substance. In the Examples, which will be described later, a copolymer of vinylidene fluoride and hexafluoropropylene (PVDF-HFP) or poly(vinylidene fluoride) (PVDF) is used as an organic high-molecular-weight compound capable of becoming a physical gel, and a methyl methacrylate/oxetanyl methacrylate copolymer or a tetrafunctional polyether acrylate is used as a crosslinking reactive substance.

Since reactive groups may be contained not in the matrix material but in the electrolytic solution as stated above, the crosslinking reactive substance may be mixed, as a component of the electrolytic solution, into the electrolytic solution. It is a matter of course that the crosslinking reactive substance may be mixed into both the matrix material and the electrolytic solution so that both the matrix material and the electrolytic solution contain reactive groups.

The sealing material 15 is not particularly limited so long as the sealing material 15 is capable of sealing the multilayer structure 11, which is configured of the positive electrode 12, the negative electrode 13, and the hard gel electrolyte 14. In the case where the electrochemical device is the lithium ion battery 10, representative examples of the sealing material 15 include known multilayer films and known metallic cans. Representative examples of the multilayer films include, but are not limited to, ones obtained by laminating a resin film, e.g., polypropylene (PP), to a metal foil, e.g., an aluminum foil or stainless-steel foil. In the case where the electrochemical device is a dye-sensitized solar cell, examples of the sealing material 15 include known sealant.

The lithium ion battery 10 shown in FIG. 1 includes no separator. This is because the hard gel electrolyte 14 held by the positive electrode 12 and negative electrode 13 can function like a separator. The lithium ion battery 10 may separately include a separator, and may include members, etc. other than the positive electrode 12, negative electrode 13, and hard gel electrolyte 14.

[Method for Producing Electrochemical Device]

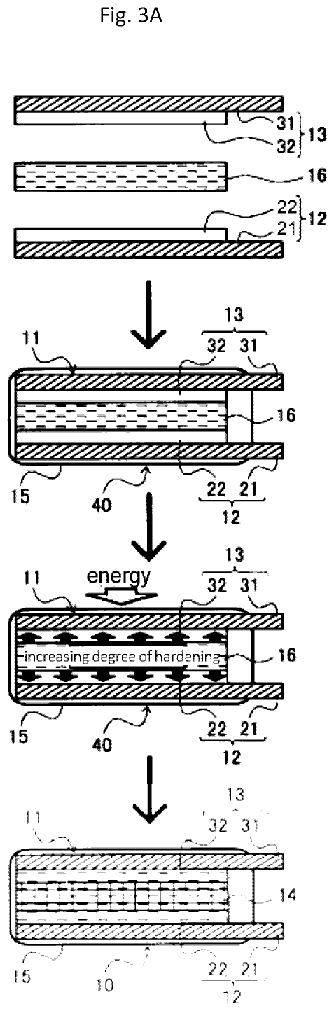

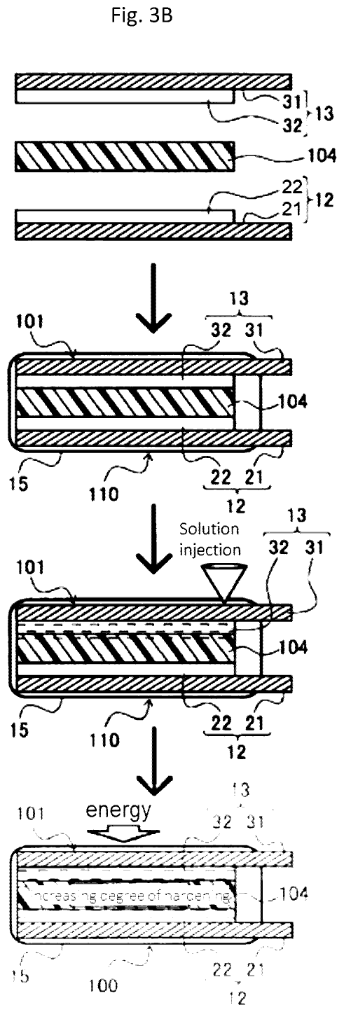

The method for producing an electrochemical device according to this disclosure is explained in detail below using, as an example, the lithium ion battery 10 described above by reference to FIG. 2 and FIGS. 3(A) and 3(B).

The method for producing an electrochemical device according to this disclosure only requires to at least include a step for increasing the degree of hardening of electrolyte, as shown in FIG. 2. The step for increasing the degree of hardening of electrolyte, in this disclosure, is a step in which reactive groups of a gel electrolyte are caused to proceed a crosslinking reaction while holding the gel electrolyte between a pair of electrodes, thereby increasing the degree of hardening of the gel electrolyte. In this step, some of the electrolytic solution is caused to seep out from the gel electrolyte as the degree of hardening of the gel electrolyte increases, that is, as the crosslinking reaction of the reactive groups contained in the gel electrolyte proceeds.

The seepage of some of the electrolytic solution from the gel electrolyte accompanies an increase in the degree of hardening (progress of the crosslinking reaction of reactive groups) and, hence, the gel electrolyte itself is in the state of sufficiently containing the remaining electrolytic solution. Furthermore, since some of the electrolytic solution seeps out gradually as the degree of hardening increases, the electrolytic solution is discharged as if it oozes out from the gel electrolyte in the step for increasing the degree of hardening of electrolyte. The electrolytic solution, which has thus seeped out is supplied to the contact surfaces of the pair of electrodes. A sufficient contact area is hence maintained at the interface between the gel electrolyte and each electrode.

Even after the hardening of the gel electrolyte has proceeded to form a hard gel electrolyte, a sufficient contact area is maintained at the interface between the hard gel electrolyte and each electrode because of the electrolytic solution, which has seeped out. Especially in cases when either or both of the contact surfaces of the pair of electrodes are porous, the electrolytic solution, which has seeped out, is satisfactorily retained in the contact surface(s) of the electrodes. Because of this, a sufficient contact area can be more satisfactorily maintained at the interface between the hard gel electrolyte and the electrode(s). Electrochemical devices are usually required to retain the electrolytic solution without allowing the electrolytic solution to seep out. In this disclosure, however, some of the electrolytic solution is purposely caused to seep out as the degree of hardening increases. The electrochemical device thus obtained can hence be effectively inhibited from having increased reaction resistance.

Methods for causing the crosslinking reaction of the reactive groups to proceed are not particularly limited. Representative examples thereof include a method in which energy is supplied to the gel electrolyte from outside. Examples of the energy to be supplied include, but a not limited to, thermal energy and electromagnetic-wave energy. Examples of methods for supplying thermal energy include a method in which the multilayer structure is heated to or held at a temperature within a given range. Examples of methods for supplying electromagnetic-wave energy include irradiation with ultraviolet light and irradiation with radiation. Irradiation with infrared light can be both a method of supplying electromagnetic-wave energy and a method of supplying thermal energy.

The term “hard gel electrolyte” means a gel electrolyte which is in the state of having a sufficiently increased degree of hardening, that is, which is in the state wherein the crosslinking reaction of the reactive groups contained in the matrix material or electrolytic solution has proceeded sufficiently. Because of this, in the hard gel electrolyte, substantially all the reactive groups contained in the matrix material or electrolytic solution have not necessarily gone through the crosslinking reaction. The degree to which the crosslinking has proceeded (degree to which the degree of hardening has increased) can be suitably regulated in accordance with various requirements for the hard gel electrolyte.

In the step for increasing the degree of hardening of electrolyte, a pressure may be applied to the gel electrolyte simultaneously with the progress of the crosslinking reaction of the reactive groups. Namely, in the step for increasing the degree of hardening of electrolyte, pressure may be applied to the gel electrolyte in the state of being held between the positive electrode and the negative electrode (in the state of having been included in the multilayer structure), in addition of the supply of energy. Conditions for the application of pressure are not particularly limited, and can be suitably set in accordance with various factors including the kind of the electrochemical device, the kind of the gel electrolyte, and a thickness range required of the hard gel electrolyte. Methods for applying pressure are not particularly limited, and a known method can be advantageously used.

In the method for producing an electrochemical device according to this disclosure, a multilayer-structure production step may be performed before the step for increasing the degree of hardening of electrolyte, as shown in FIG. 2. In the multilayer-structure production step, a gel electrolyte is disposed between a pair of electrodes to produce a multilayer structure. This step is not particularly limited in specific production methods therefor. Representatively, use may be made of: a method in which a composition that becomes a gel electrolyte is applied to the contact surface of one of a pair of electrodes and the other electrode is placed thereon; or a method in which a gel electrolyte which has been formed as a sheet-shaped gel is interposed between a pair of electrodes.

In cases when the electrochemical device is the lithium ion battery 10 described above or the like, the method for producing an electrochemical device according to this disclosure may include a sealing step which is performed before the step for increasing the degree of hardening of electrolyte and in which the multilayer structure obtained in the multilayer-structure production step is encapsulated with an sealing material. There are no particular limitations on specific methods for sealing, and a sealing method according to various factors including the structure of the electrochemical device and the kind of the sealing material may be employed. For example, in cases when the electrochemical device is the lithium ion battery 10 and the sealing material is a multilayer film, the multilayer structure may be laminate-packaged. In cases when the sealing material is a metallic can, use may be made of a method in which the multilayer structure is introduced into the metallic can and this metallic can is sealed. In this case, the multilayer structure may be wound into a roll and enclosed in the metallic can. In cases when the electrochemical device is a dye-sensitized solar cell and the sealing material is a sealant, use may be made of a method in which the periphery of the multilayer structure is sealed with the sealant.

In the example shown in FIG. 2, the gel electrolyte increases in the degree of hardening to become a hard gel electrolyte through the multilayer-structure production step, the sealing step, and the step for increasing the degree of hardening of electrolyte, thereby completing an electrochemical device. However, the method for producing an electrochemical device according to this disclosure is not limited to the steps shown in FIG. 2, and may be any methods which at least include the step for increasing the degree of hardening of electrolyte.

The method for producing an electrochemical device according to this disclosure may include steps other than those shown in FIG. 2. For example, the method, depending on the kind of the electrochemical device, may include a finishing step for completing the electrochemical device, after the step for increasing the degree of hardening of electrolyte. The method may include an electrode production step for producing the pair of electrodes, before the multilayer-structure production step. The electrode production step may include a step (active-material layer formation step) in which one or two active-material layers (a positive-electrode active-material layer 22 and/or a negative-electrode active-material layer 32) are formed, by application of a coating fluid, on the surface(s) (surface(s) to be in contact with the hard gel electrolyte 14) of one or two electrode bases (a positive-electrode base material 21 and/or a negative-electrode base material 31) as described above. This coating fluid may contain a gel ingredient similar to the gel electrolyte or hard gel electrolyte as described above.

An example in which the method for producing an electrochemical device shown in FIG. 2 is applied to a method for producing the lithium ion battery 10 shown in FIG. 1 corresponds to the schematic flow diagrams shown in FIG. 3(A). Meanwhile, the schematic flow diagrams shown in FIG. 3(B) show an example of a conventional method for producing a lithium ion battery 100.

As the uppermost diagram in FIG. 3(A) shows, in the method for producing a lithium ion battery 10, a gel electrolyte 16 is first disposed between a positive electrode 12 and a negative electrode 13, which are a pair of electrodes, to produce a multilayer structure 11 (multilayer-structure production step). Next, as the second diagram from the top in FIG. 3(A) shows, the multilayer structure 11 produced is sealed with a sealing material 15 to produce a sealed structure 40, which is an electrochemical device before degree of hardening increase (sealing step).

In each of the lithium ion battery 10 according to this disclosure shown in FIG. 3(A) and the conventional lithium ion battery 100 shown in FIG. 3(B), the positive electrode 12 has a configuration including a positive-electrode active-material layer 22 superposed on one surface of a positive-electrode base material 21 and the negative electrode 13 has a configuration including a negative-electrode active-material layer 32 superposed on one surface of a negative-electrode base material 31 (see FIG. 1). However, the specific configurations of the positive electrode 12 and negative electrode 13 are not limited to these, as stated above.

In FIG. 3(A) and FIG. 3(B), some of the members are indicated by hatching in accordance with the schematic cross-sectional view of the lithium ion battery 10 shown in FIG. 1. However, for convenience of explaining the seepage of an electrolytic solution, the gel electrolyte 16, which has not increased in the degree of hardening, in FIG. 3(A), is indicated only with a “liquid-indicating hatch”, which means the inclusion of an electrolytic solution. Furthermore, in FIG. 3(A), the hard gel electrolyte 14, which has increased in the degree of hardening, is indicated with both a lattice hatch similar to that in FIG. 1 and, superposed thereon, a “liquid-indicating hatch”, which means the inclusion of an electrolytic solution.

Next, as the third diagram from the top in FIG. 3(A) shows, energy is supplied from outside to the sealed structure 40 as shown by the open block arrow (heat treatment, etc.), thereby increasing the degree of hardening of the gel electrolyte 16 included in the multilayer structure 11. In this treatment, a crosslinking reaction proceeds in the gel electrolyte 16 and, with the progress of the crosslinking reaction, some of the electrolytic solution contained in the gel electrolyte 16 seeps out toward the positive-electrode active-material layer 22 of the positive electrode 12 and toward the negative-electrode active-material layer 32 of the negative electrode 13 as shown by the solid block arrows (step for increasing the degree of hardening of electrolyte).

Thereafter, as the lowermost diagram in FIG. 3(A) shows, the gel electrolyte 16 sufficiently increases in the degree of hardening to become a hard gel electrolyte 14. Thus, a lithium ion battery 10, which is an electrochemical device after degree of hardening increase, is completed.

Meanwhile, conventional methods for producing an electrochemical device employing a gel electrolyte as the electrolyte, for example, have the following problems.

A prepolymer is generally used for making an electrolytic solution into gel, and the prepolymer is dissolved in the electrolytic solution beforehand. This electrolytic solution is referred to as a “prepolymer electrolytic solution” for convenience of explanation. In producing an electrochemical device in many cases, the prepolymer electrolytic solution is injected into an electrochemical device and the prepolymer is reacted in a subsequent heat treatment or the like to proceed making the prepolymer electrolytic solution into gel. However, since the prepolymer electrolytic solution has higher viscosity than ordinary electrolytic solutions, the injection of the electrolytic solution requires a prolonged time period. This may affect the efficiency of electrochemical-device production.

In cases when the electrochemical device is a large battery, the high-viscosity prepolymer electrolytic solution needs to be injected in a large amount and, hence, a shortage in electrolytic-solution injection is prone to result. Such shortage in the injection of the prepolymer electrolytic solution may make it impossible to attain sufficient device performances.

In the method for producing an electrochemical device according to this disclosure, a hard gel electrolyte 14 is formed by the step for increasing the degree of hardening of electrolyte, as in the example for producing the lithium ion battery 10 described above. Because of this, the injection of an electrolytic solution, which is an essential step in conventional production methods, is unnecessary. Furthermore, even in cases when the lithium ion battery 10 is large, the possibility of an injection shortage can be avoided because of no need of injecting an electrolytic solution. As a result, not only the production steps can be rendered efficient but also satisfactory device performances can be rendered possible.

For example, in the conventional method for producing a lithium ion battery 100, a multilayer-structure production step and a sealing step are conducted, as in the method for producing a lithium ion battery 10 according to this disclosure, as shown by the uppermost diagram and the second diagram from the top in FIG. 3(B). Specifically, a separator 104 (e.g., a porous membrane made of a polyolefin) is disposed, in place of the gel electrolyte 16, between a positive electrode 12 and a negative electrode 13 to produce a multilayer structure 101, and this multilayer structure 101 is sealed with a sealing material 15 to produce a sealed structure 110 which is an electrochemical device before degree of hardening increase.

The conventional method for producing a lithium ion battery 100 then necessitates a step for injecting an electrolytic solution into the sealed structure 110 (electrolytic-solution injection step) as shown by the third diagram from the top in FIG. 3(B). In cases when the electrolyte of the conventional lithium ion battery 100 is a gel electrolyte, a “prepolymer electrolytic solution” in which a prepolymer has been dissolved beforehand is used as the electrolytic solution. Because of this, the prepolymer electrolytic solution, which has high viscosity, is injected into the sealed structure 110. Thereafter, as the lowermost diagram in FIG. 3(B) shows, the prepolymer is reacted by supplying energy from outside (heat treatment, etc.) to proceed making the prepolymer electrolytic solution into gel, thereby completing the conventional lithium ion battery 100. The step in which the prepolymer is reacted to proceed making the prepolymer electrolytic solution into gel can be regarded as a conventional step for increasing the degree of hardening of electrolyte.

Since the prepolymer electrolytic solution has high viscosity as stated above, the electrolytic-solution injection step requires a prolonged time period for injecting the prepolymer electrolytic solution. In addition, in cases when the electrochemical device is a large battery, the high-viscosity prepolymer electrolytic solution needs to be injected in a large amount and, hence, a shortage in electrolytic-solution injection is prone to occur. Thus, in the conventional method for producing the lithium ion battery 100, not only the production steps may be unable to be sufficiently rendered efficient but also the shortage in injection, etc. may result in insufficient battery performances and insufficient long-term stability.

In contrast, in the method for producing a lithium ion battery 10 (method for producing an electrochemical device) according to this disclosure, the gel electrolyte 16 in the state of being held between the positive electrode 12 and the negative electrode 13 is increased in the degree of hardening, during which some of the electrolytic solution is caused to seep out from the gel electrolyte 16 as if it oozes out. Because of this, even after the gel electrolyte 16 has increased in the degree of hardening to become a hard gel electrolyte 14, this hard gel electrolyte 14 contains the remaining electrolytic solution in a sufficient amount and the electrolytic solution which has seeped out comes into a satisfactory contact with the contact surfaces of the positive electrode 12 and negative electrode 13. Thus, a satisfactory contact area can be attained at the interface between the hard gel electrolyte 14 and the positive electrode 12 and at the interface between the hard gel electrolyte 14 and the negative electrode 13. Consequently, the reaction resistance can be effectively inhibited from increasing.

In particular, in cases when either the positive-electrode active-material layer 22, which constitutes the contact surface of the positive electrode 12, and/or the negative-electrode active-material layer 32, which constitutes the contact surface of the negative electrode 13, is a porous layer, the electrolytic solution which has seeped out can be satisfactorily held by the electrode surface(s) (contact surface(s)). Consequently, the area of contact with the hard gel electrolyte 14 can be maintained even more satisfactorily.

In addition, since the gel electrolyte 16 is a gel-state object configured of a matrix material and an electrolytic solution, not only the injection of an electrolytic solution into a separator 104, which is an essential step in the conventional method for producing a lithium ion battery 100, is unnecessary but also the shortage in injection which may occur in cases when the lithium ion battery 100 is large can be avoided. As a result, the production steps can be rendered efficient and satisfactory device performances and long-term stability can be rendered possible.

Furthermore, since the hard gel electrolyte 14 can function as a separator 104, in the lithium ion battery 10 according to this disclosure, a separator 104, which is a constituent element of the conventional lithium ion battery 100, is no longer essential. It is hence possible to reduce the number of members necessary for constituting the lithium ion battery 10.

Some conventional electrochemical devices employ an electrolyte, which is not a gel electrolyte but a solid electrolyte. Known methods for forming a solid electrolyte include, for example, a method in which a solid electrolyte is formed on an electrode by applying a coating fluid. However, since the solid electrolyte is in point contact with the electrodes, there is a possibility that the electrochemical device might have increased resistance in contact between the solid electrolyte and each electrode in case where the number of sites where the point contact occurs is too small. There also are cases where the electrodes change in volume when the electrochemical device works. In such cases, the volume changes of the electrodes may, for example, impair the state of contact between the solid electrolyte and each electrode and this may shorten the life of the electrochemical device, making it impossible to attain satisfactory long-term stability. Consequently, there is a possibility that even the electrochemical device equipped with a solid electrolyte might be unable to sufficiently have satisfactory device performances.

In contrast, in the method for producing a lithium ion battery 10 (method for producing an electrochemical device) according to this disclosure, the gel electrolyte 16 is caused to have an increased degree of hardening in the step for increasing the degree of hardening of electrolyte and, simultaneously therewith, some of the electrolytic solution is caused to seep out from the gel electrolyte 16 as if it oozes out. Because of this, even after the gel electrolyte 16 has become a hard gel electrolyte 14, this hard gel electrolyte 14 contains a sufficient amount of an electrolytic solution and the electrolytic solution, which has seeped out is in satisfactory contact with the contact surfaces of the positive electrode 12 and negative electrode 13.

Thus, a satisfactory contact area is rendered possible at the interface between the hard gel electrolyte 14 and each of the positive electrode 12 and negative electrode 13. The reaction resistance can hence be effectively inhibited from increasing. In addition, even if the positive electrode 12 or the negative electrode 13 changes in volume when the lithium ion battery 10 works, the positive electrode 12 and the negative electrode 13 can be kept in satisfactory areal contact with the hard gel electrolyte 14 by the electrolytic solution which has seeped out. Consequently, the lithium ion battery 10 is inhibited from having a shortened battery life and satisfactory long-term stability can be rendered possible.

### EXAMPLES

The method for producing an electrochemical device according to this disclosure is explained in more detail by reference to Examples and Comparative Example, but the present invention is not limited to the Examples. A person skilled in the art can variously change or modify the method without departing from the scope of the present invention.

### Example 1

[Production of Positive Electrode]

A hundred (100) grams of LiNi_{1/3}CO_{1/3}Mn_{1/3}O₂ (NCM) as a positive-electrode active material, 7.8 g of carbon black (product name, Super-P; manufactured by TIMCAL Graphite & Carbon) as a conductive aid, 3.3 g of poly(vinylidene fluoride) (PVDF; weight-average molecular weight Mw, about 300,000; product name, #1300; manufactured by Kureha Corp.) as a binder resin, and 38.4 g of N-methyl-2-pyrrolidone (NMP) as a dispersion medium were weighed out and mixed together using a planetary mixer to prepare a coating fluid having a solid content of 51% for forming positive-electrode active-material layers. This coating fluid was applied, with an applicator, to an aluminum foil having a thickness of 15 μm (positive-electrode base material) and dried at 130° C. Thereafter, the coated aluminum foil was roll-pressed to obtain a positive electrode having a positive-electrode active-material layer in an amount of 2.3 mg/cm².

[Preparation of Gel-Electrolyte Coating Fluid]

The following operation was conducted in a dry air atmosphere having a dew point of −50° C. or lower. A hundred (100) parts by weight of ethylene carbonate/diethyl carbonate=3/7 (volume ratio) as a solvent was mixed with 18 parts by weight of lithium hexafluorophosphate (LiPF₆), 10 parts by weight of a copolymer of vinylidene fluoride and hexafluoropropylene (PVDF-HFP; weight-average molecular weight Mw, about 380,000; product name, #8500; manufactured by Kureha Corp.), and 5 parts by weight of a methyl methacrylate/oxetanyl methacrylate copolymer (weight-average molecular weight Mw, about 400,000; product name, ELEXCEL ACG; manufactured by Dai-ichi Kogyo Seiyaku Co., Ltd.). This mixture was kneaded with a planetary centrifugal mixer until the mixture become homogeneous. Thus, a gel-electrolyte coating fluid was prepared.

[Production of Lithium Ion Battery]

The gel electrolyte produced in the manner described above was applied with an applicator to the positive electrode produced in the manner described above, in such an amount as to form a film having a thickness of about 40 μm. Thereafter, a disk having a diameter of 14 mm was punched out to obtain a punched-out disk configured of the positive electrode and the gel electrolyte.

A polyimide film (thickness, 25 μm) having a ring shape with an inner diameter of 12 mm and an outer diameter of 20 mm was prepared as a spacer for preventing positive electrode/negative electrode contact. This polyimide film was placed on the punched-out disk. A lithium foil having a diameter of 12 mm as a negative electrode was placed on the punched-out disk so as not to overlap with the ring-shaped polyimide film, thereby producing a multilayer structure (multilayer-structure production step).

The multilayer structure obtained was fixed with a coin cell jig (manufactured by TomCell, LLC) and enclosed tightly in the coin cell jig, which was sealed. Thus, a sealed structure was produced as an electrochemical device before degree of hardening increase (sealing step).

Thereafter, the sealed structure was allowed to stand still in a 60° C. thermostatic chamber for 18 hours to thereby cause the crosslinking reaction of reactive groups contained in the gel electrolyte to proceed, and was then returned to room temperature (step for increasing the degree of hardening of electrolyte). Through this treatment, the gel electrolyte hardened to become a hard gel electrolyte. Thus, a lithium ion battery according to Example 1 was obtained as an electrochemical device after degree of hardening increase.

[Battery Evaluation for Power Generation Characteristics]

Using a charge/discharge tester (product name, TOSCAT3100, manufactured by Toyo System Co., Ltd.), the obtained lithium ion battery according to Example 1 was charged under the conditions of 25° C., at an hour rate of 0.2 C and then discharged under the conditions of hour rates of 0.2 C to 1 C. The battery was evaluated for capacity retention in terms of the proportion of the 1 C discharge capacity to the 0.1 C discharge capacity (Q1 C/Q0.1 C). As a result, the lithium ion battery according to Example 1 was able to show a capacity retention of 90%.

### Example 2

A lithium ion battery according to Example 2 was obtained in the same manner as in Example 1, except that in preparing the gel-electrolyte coating fluid, 10 parts by weight of a tetrafunctional polyether acrylate (weight-average molecular weight Mw, about 11,000; product name, ELEXCEL TA-210; manufactured by Dai-ichi Kogyo Seiyaku Co., Ltd.) was blended in place of the 5 parts by weight of the methyl methacrylate/oxetanyl methacrylate copolymer and 0.57 parts by weight of 2,2′-azobis(2,4-dimethylvaleronitrile) (product name, V-65; manufactured by Wako Pure Chemical Industries, Ltd.) was blended as an additive.

The obtained lithium ion battery according to Example 2 was evaluated for capacity retention in the same manner as in Example 1. As a result, the lithium ion battery according to Example 2 was able to show a capacity retention of 86%.

### Example 3

A lithium ion battery according to Example 3 was obtained in the same manner as in Example 1, except that in preparing the gel-electrolyte coating fluid, 10 parts by weight of PVDF (product name, #1300; manufactured by Kureha Corp.) was blended in place of the PVDF-HFP.

The obtained lithium ion battery according to Example 3 was evaluated for capacity retention in the same manner as in Example 1. As a result, the lithium ion battery according to Example 3 was able to show a capacity retention of 90%.

### Comparative Example

A lithium ion battery according to Comparative Example was obtained in the same manner as in Example 1, except that in preparing the gel-electrolyte coating fluid, the 5 parts by weight of the methyl methacrylate/oxetanyl methacrylate copolymer was not blended.

The obtained lithium ion battery according to Comparative Example was evaluated for capacity retention in the same manner as in Example 1. As a result, the lithium ion battery according to Comparative Example suffered short-circuiting during the charge/discharge test and was unable to work normally.

As described above, the method for producing an electrochemical device according to this disclosure includes the step for increasing the degree of hardening of electrolyte, in which a crosslinking reaction of reactive groups contained in a gel electrolyte is caused to proceed while the gel electrolyte being held between a pair of electrodes, thereby increasing the degree of hardening of the gel electrolyte, and some of the electrolytic solution is caused to seep out from the gel electrolyte as the crosslinking reaction proceeds.

In the step for increasing the degree of hardening of electrolyte, the degree of hardening of the gel electrolyte held between the pair of electrodes is caused to increase and, simultaneously therewith, some of the electrolytic solution is caused to seep out from the gel electrolyte as if it oozes out. Because of this, even after the gel electrolyte has had a sufficiently increased degree of hardening to become a hard gel electrolyte, this hard gel electrolyte contains a sufficient amount of a gel electrolytic solution and the electrolytic solution, which has seeped out is in satisfactory contact with the contact surfaces of the pair of electrodes. Thus, a satisfactory contact area is rendered possible at the interface between the electrolyte and each electrode. The reaction resistance can hence be effectively inhibited from increasing.

In addition, since the gel electrolyte is a gel-state object configured of a matrix material and an electrolytic solution, not only the injection of an electrolytic solution, which is an essential step in conventional production methods, is unnecessary but also the shortage in electrolytic-solution injection can be avoided even in cases when the electrochemical device is large. As a result, the production steps can be rendered efficient and satisfactory device performances and long-term reliability can be rendered possible. Furthermore, since the hard gel electrolyte can function as a separator, a separator becomes no longer essential as a constituent element of the electrochemical device. It is hence possible to reduce the number of members necessary for constituting the electrochemical device.

The present invention should not be construed as being limited to the embodiments described above and can be variously modified within the scope of the claims. Embodiments each obtained by suitably combining technical means respectively disclosed in different embodiments or in a plurality of modifications are also included in the technical scope of the present invention.

The present invention can be advantageously used extensively in the field of producing electrochemical devices such as lithium ion batteries, dye-sensitized solar cells, electric double-layer capacitors, etc.
10 Lithium ion battery
11 Multilayer structure
12 Positive electrode
13 Negative electrode
14 Hard gel electrolyte
15 Sealing material
16 Gel electrolyte
21 Positive-electrode base
22 Positive-electrode active-material layer
31 Negative-electrode base
32 Negative-electrode active-material layer
40 Sealed structure

1. A method for producing an electrochemical device comprising a pair of electrodes and an electrolyte interposed therebetween,
the electrolyte being a gel electrolyte that is a gel-state object configured of at least a matrix material and an electrolytic solution, that contains reactive groups capable of crosslinking, and that has an increased degree of hardening,
the method comprising a step for increasing degree of hardening of electrolyte, wherein a crosslinking reaction of the reactive groups is caused to proceed while the gel electrolyte being held between the pair of electrodes, to increase the degree of hardening of the gel electrolyte, and some of the electrolytic solution is caused to seep out from the gel electrolyte as the crosslinking reaction proceeds.

2. The method for producing an electrochemical device according to claim 1, wherein the pair of electrodes comprises a positive electrode and a negative electrode and
at least one of the positive electrode and the negative electrode has a porous surface as a surface in contact with the electrolyte.

3. The method for producing an electrochemical device according to claim 1, wherein at least one of the pair of electrodes comprises an active-material layer formed in the surface in contact with the electrolyte, and
the active-material layer is formed by applying a coating fluid containing an active material.

4. The method for producing an electrochemical device according to claim 3, wherein the coating fluid contains either the gel electrolyte or a hard gel electrolyte obtained by causing the gel electrolyte to have an increased degree of hardening.

5. The method for producing an electrochemical device according to claim 1, further comprising a sealing step which is performed before the step for increasing the degree of hardening of electrolyte and in which a multilayer structure comprising the pair of electrodes and the gel electrolyte held therebetween is sealed with a sealing material.

6. The method for producing an electrochemical device according to claim 5, wherein, in the step for increasing the degree of hardening of electrolyte, energy is supplied to the gel electrolyte from outside the multilayer structure to cause the crosslinking reaction to proceed.

7. The method for producing an electrochemical device according to claim 1, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

8. The method for producing an electrochemical device according to claim 1, wherein the electrochemical device is a lithium ion battery, a dye-sensitized solar cell, or an electric double-layer capacitor.

9. The method for producing an electrochemical device according to claim 2, wherein at least one of the pair of electrodes comprises an active-material layer formed in the surface in contact with the electrolyte, and
the active-material layer is formed by applying a coating fluid containing an active material.

10. The method for producing an electrochemical device according to claim 2, further comprising a sealing step which is performed before the step for increasing the degree of hardening of electrolyte and in which a multilayer structure comprising the pair of electrodes and the gel electrolyte held therebetween is sealed with a sealing material.

11. The method for producing an electrochemical device according to claim 3, further comprising a sealing step which is performed before the step for increasing the degree of hardening of electrolyte and in which a multilayer structure comprising the pair of electrodes and the gel electrolyte held therebetween is sealed with a sealing material.

12. The method for producing an electrochemical device according to claim 4, further comprising a sealing step which is performed before the step for increasing the degree of hardening of electrolyte and in which a multilayer structure comprising the pair of electrodes and the gel electrolyte held therebetween is sealed with a sealing material.

13. The method for producing an electrochemical device according to claim 2, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

14. The method for producing an electrochemical device according to claim 3, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

15. The method for producing an electrochemical device according to claim 4, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

16. The method for producing an electrochemical device according to claim 5, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

17. The method for producing an electrochemical device according to claim 6, wherein
the pair of electrodes comprises a positive electrode and a negative electrode and
the step for increasing the degree of hardening of electrolyte further comprises applying pressure to the gel electrolyte while the gel electrolyte being held between the positive electrode and the negative electrode.

18. The method for producing an electrochemical device according to claim 2, wherein the electrochemical device is a lithium ion battery, a dye-sensitized solar cell, or an electric double-layer capacitor.

19. The method for producing an electrochemical device according to claim 3, wherein the electrochemical device is a lithium ion battery, a dye-sensitized solar cell, or an electric double-layer capacitor.

20. The method for producing an electrochemical device according to claim 4, wherein the electrochemical device is a lithium ion battery, a dye-sensitized solar cell, or an electric double-layer capacitor.
